(19) United States
(12) Patent Application Publication
(10) Pub. No.: US 2006/0053440 A1
(43) Pub. Date: Mar. 9, 2006

(54) Content access control from an information carrier player

(76) Inventors: Declan Patrick Kelly, Eindhoven (NL); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,704

(22) PCT Filed: Dec. 5, 2003
(86) PCT No.: PCT/IB03/05827

§ 371 Date: Jun. 24, 2005

(30) Foreign Application Priority Data
Dec. 30, 2002 (EP) 02293266.9

(51) Int. Cl. H04N 7/16; H04N 7/173

(52) U.S. Cl. 725/28; 725/146; 725/116; 725/25

(57) ABSTRACT

The invention relates to a method of controlling a user access to a server content from an information carrier player (101), said server being intended to contain data associated with a rating level (RL), said method comprising; a) a parental control access step (104) based on a current parental control level (Current PCL i), b) a control step (107) based on a comparison between said current parental control level (Current PCL i) and the rating level of said data, for selecting authorized data to be displayed on said information carrier player (101).

### FIELD OF THE INVENTION

The invention relates to a method of controlling a user access to a server content from an information carrier player comprising a parental control access.

The invention applies to information carrier players implementing a parental control level feature, such as DVD players.

### BACKGROUND OF THE INVENTION

The DVD Forum has established a working group AH1-12 to standardize Web connected DVD, known as WebDVD. These new specifications are an extension of current DVD-Video specifications. They describe that DVD-Video discs compliant with these new specifications will be published with links to specific Websites containing additional content directly related to the content of the DVD disc being played. These specific Websites may include new navigation menus and content, which the player can download and use instead of original menus provided by the DVD disc.

Players supporting WebDVD comprise communication means for connecting to Web servers which contain said additional content. Advantageously, such communication means can also be used to access any other general Websites for general Web browsing.

In parallel, DVD players nowadays include a parental control feature. The purpose of this feature is to disable the playing of DVD discs that are deemed unsuitable for children. To this end, some DVDs are encoded with a specific parental control level. If the parental control level of the disc is higher than the parental control level of the DVD player (set by parents in using a PIN code), the player will not play the disc. This feature allows parents to limit the type of DVD content that can be played on the player.

In DVD players implementing such a parental control level feature, this feature is limitative and no longer relevant since it cannot restrict or control the access to general Websites deemed unsuitable for children.

### OBJECT AND SUMMARY OF THE INVENTION

It is an object of the invention to propose a method of controlling a user access to a server content from an information carrier player comprising a parental control access.

The method of controlling according to the invention takes either advantage of the existing parental control access used in information carrier players, and the fact that the data stored on some servers which the user try to access are associated with a rating level similar to a parental control level.

The method according to the invention comprises a control step based on a comparison between said current parental control level and the rating level of said data for selecting authorized data to be displayed on said information carrier player.

The setting of the parental control level in the player is not only used for controlling the access to the information carrier content (and to the Web servers linked to this information carrier), but also for controlling the access of Websites in the case of general Web browsing.

According to an additional characteristic, the method comprises a look-up table step for establishing a correspondence between the rating level classification of said data and the parental control level classification of said information carrier player.

This characteristic allows the player to be adaptable to any labelling system which associates a rating level with data.

The invention also relates to an information carrier player comprising processing means for controlling a user access to a server content, said information carrier player comprising parental control access means based on a current parental control level, said server content comprising data associated with a rating level, said information carrier player also comprising control means based on a comparison between said current parental control level and the rating level of said data for selecting authorized data to be displayed on said information carrier player.

According to an additional characteristic, the information carrier player comprises look-up means for establishing a correspondence between the rating level classification of said data and the parental control level classification of said information carrier player.

The invention also relates to a computer program comprising code instructions for implementing the steps of the method according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts the method according to the invention of controlling a user access to a server content.

### DETAILED DESCRIPTION OF THE INVENTION

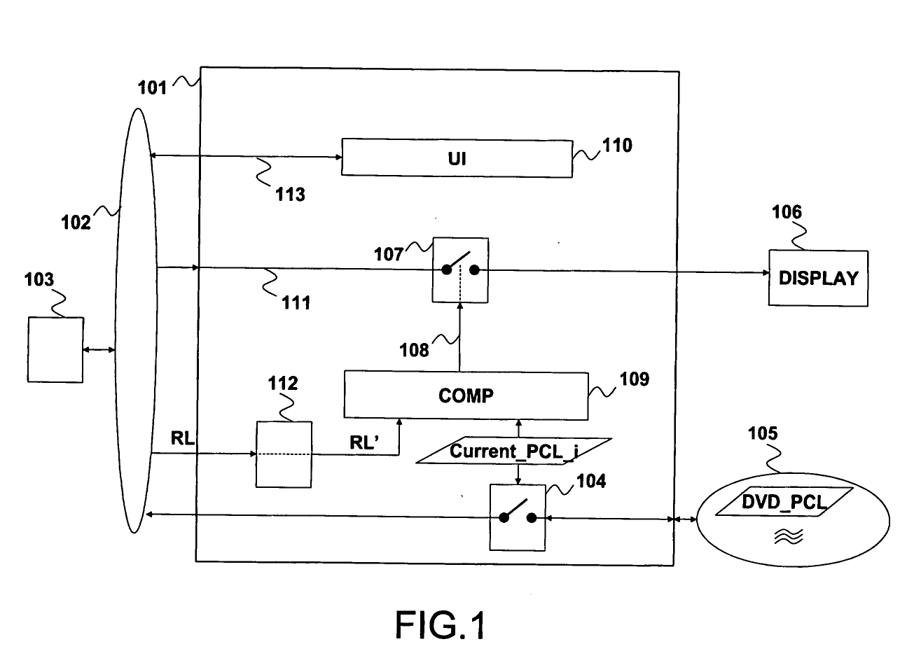

FIG. 1 depicts a first method according to the invention of controlling a user access to a server content. This Figure shows an information carrier player 101 communicating via a network 102 with a server 103. For example, it shows a DVD player 101 communicating via the Internet network with a distant Website 103.

The player 101 comprises a parental control access step 104 based on the Motion Picture Association of America (MPAA) rating system.

The following Table 1 lists the individual parental control levels (PCL) the player can be set to. The highest PCL=8 relates to adult contents, while the lowest PCL=1 relates to kid safe contents.

TABLE 1
MPAA Rating

| | Parental control | |
|---|---|---|
| MPAA Rating | level (PCL) | General Description |
| | 8 | Unrated (most restricted audience) |
| NC-17 | 7 | NC-17 Adult theme or content, not |
| | | suitable for children under 17 |
| R | 6 | Restricted (mature audience) |
| | 5 | Mature teenage audience |
| PG-13 | 4 | Parental guidance suggested, |
| | | unsuitable for children under 13 |
| | | (teenage audience) |
| PG | 3 | Parental guidance suggested |
| | | (mature young audience) |
| | 2 | Most audiences |
| G | 1 | Suitable for general audiences |
| | | (general, unrestricted audience) |

This parental control access step is used for controlling the access to the content of an information carrier 105 (and as a consequence a control access to the specific Websites linked to this DVD). The step 105 is similar to a switch controlled by a control signal derived from a comparison between the parental control level of the disc (designated by DVD_PCL) and the current parental control level (designated by Current_PCL_i) set in the player 101. A user can access the disc content (and also to the specific Websites linked to this DVD) only if Current_PCL_i is higher than or equal to DVD_PCL. The index i corresponds to one of the MPPA rating values as defined in Table 1.

The player 101 is associated with a display 106 in charge of displaying the content of the accessed server, but also the content of the DVD disc 105 and the data of a specific server linked to this disc.

The invention takes advantage of the fact that data stored on some servers which the user may try to access are associated with a rating level (referred to as RL in the following), such a rating level being similar to a parental control level.

For example, the Internet Content Rating Association and the Recreational Software Advisory Council on the Internet propose labelling systems for owners of Websites to subdivide their data into main categories:

Chat,

The language used on the site,

The nudity and sexual content of a site,

The violence depicted on the site,

Others categories such as gambling, drugs and alcohol.

Each category may comprise sub-categories for better identification the data content.

Such a labelling of data is intended to be used in Web browsers in personal computers. The parameter settings of the Web browsers are set so as to allow only categories or sub-categories. If the Website accessed by the user comprises data having a label excluded from these settings, the respective data content cannot be displayed in the browser.

Usually, such labels are HTML-coded as meta tags in Web pages carrying data, either for a specific Web page, a specific folder of data, or for the whole content of the Website.

The method according to the invention comprises a control step 107 for selecting authorized data to be displayed on the display 106. This control step 107 is similar to a switch controlled by a control signal 108 which is generated by a comparison step 109. The comparison step 109 performs a comparison between the current parental control level Current_PCL_i and the rating level RL of the data situated on the server and accessed by a user. For accessing a server, or a specific data on a server, the user may use the user interface 110, such as a keyboard where he enters the Website or Web page address.

When the user tries to access a data content situated on a server 103, a request 113 to said server is generated by the player 101. In response, the sever 103 sends the rating level RL of said data to the player.

If the value of RL is such that, considering the current parental control level Current_PCL_i, data 111 are deemed unsuitable for children, the comparison step 109 generates a control signal 108 having a first state which opens the switch 107. As a consequence, the display of the data 111 is not possible.

If the value of RL is such that, considering the current parental control level Current_PCL_i, data 111 are not deemed unsuitable for children, the comparison step 109 generates a control signal 108 having a second state which closes the switch 107. As a consequence, the display of the data 111 is possible.

The comparison between the current parental control level Current_PCL_i and the rating level RL of the data may not always be directly possible, for example if the number of categories of rating levels is not identical to the number of categories of the MPAA Rating. Thus, the method according to the invention advantageously comprises a look-up table step 112 for establishing a correspondence between the rating level classification of the data situated on the server and the MPAA Rating as shown in Table 1. The look-up table 112 establishes a correspondence between an input rating level RL and an output rating level RL′.

For example, it may be decided to associate categories (nudity and sexual content of a site, violence depicted on the site) with a MPPA rating having a value RL′ equal to 8, to associate categories (Chat, language used on the site) with a MPPA rating having a value RL′ equal to 7, and to associate categories (Others such as gambling, drugs and alcohol) with a MPPA rating having a value RL′ equal to 6. In that case, the comparison step 109 generates a control signal 108 having said first state if Current_PCL_i is lower than the associated MPPA rating of the data, and generates a control signal 108 having said second state if Current_PCL_i is higher than or equal to the associated MPPA rating of the data.

Obviously, alternative classifications may be made in considering the sub-categories of said categories for refining the filtering of data that the user is allowed to look at.

The method of controlling according to the invention may take place in an information carrier player, such as a DVD player, or in any portable apparatus comprising a DVD player (PDA, mobile phone . . . ).

Such a method may be implemented by means of hardware elements (such as wired electronic circuits, memories, signal processors . . . ), or alternatively by means of software elements such as computer programs comprising code instructions stored in a memory device, said code instructions being executed by a signal processor.

The words “comprise”, “comprises” and “comprising” do not exclude the presence of elements other than those listed in the claims.

1. A method of controlling, from an information carrier player (101), a user access to an information carrier (105) and to a server (103), said information carrier (105) being associated with a preset parental control level (DVD_PCL), said information carrier player (101) being associated with a current parental control level (Current_PCL_i), said server (103) being intended to contain data associated with a rating level (RL), said method of controlli02ng comprising:
a first switching step (104) controlled by a first control signal derived from a first comparison between said current parental control level (Current_PCL_i) and said preset parental control level (DVD_PCL), for authorizing or not the access to said information carrier (105),
a second switching step (107) controlled by a second control signal (108) derived from a second comparison between said current parental control level (Current_PCL_i) and said rating level (RL), for authorizing or not the access to said data.

2. A method as claimed in claim 1, comprising a preliminary look-up table step (112) for generating, from said rating level (RL), a modified rating level (RL′) intended to be used for said second comparison.

3. An information carrier player (101) intended to read an information carrier (105) which is associated with a preset parental control level (DVD_PCL), and to control a user access to a server (103) intended to contain data associated with a rating level (RL), said information carrier player (101) being associated with a current parental control level (Current_PCL_i), and comprising:
first switching means (104) controlled by a first control signal derived from a first comparison between said current parental control level (Current_PCL_i) and said preset parental control level (DVD_PCL), for authorizing or not the reading of said information carrier (105),
second switching means (107) controlled by a second control signal (108) derived from a second comparison between said current parental control level (Current_PCL_i) and said rating level (RL), for authorizing or not the access to said data.

4. An information carrier player (101) as claimed in claim 3, comprising look-up means (112) for generating, from said rating level (RL), a modified rating level (RL′) intended to be used for said second comparison.

5. A computer program comprising code instructions for implementing the steps of the method as claimed in claim 1.
